(19) United States
(12) Patent Application Publication
(10) Pub. No.: US 2004/0099572 A1
(43) Pub. Date: May 27, 2004

(54) FCC catalyst injection system having closed loop control

(76) Inventor: Martin Evans, Tolland, CT (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/445,453

(22) Filed: May 27, 2003

Related U.S. Application Data
(63) Continuation-in-part of application No. 10/374,450, filed on Feb. 26, 2003.
(63) Continuation-in-part of application No. 10/304,670, filed on Nov. 26, 2002.
(63) Continuation-in-part of application No. 10/320,064, filed on Dec. 16, 2002.

(51) Int. Cl. C10G 11/00; B01J 8/18

(52) U.S. Cl. 208/113; 208/DIG. 1; 208/146; 422/139; 422/145; 422/105; 422/144

(57) ABSTRACT

A system and method for injecting catalyst into a fluid catalyst cracking (FCC) unit is provided. In one embodiment, a system for injecting catalyst into a FCC unit includes at least one catalyst injection apparatus for providing catalyst to a fluid catalyst cracking unit, at least one sensor adapted to provide a metric indicative of the composition of a product stream produced in the fluid catalyst cracking unit, and a controller coupled to the sensor, for controlling the additions made by the catalyst injection system in response to the metric provided by the sensor. Another embodiment of the invention comprises a method for injecting catalyst from a catalyst injection system into a FCC unit that includes the steps of dispensing catalyst for a catalyst injection system into a fluid catalytic cracking unit, sensing an output in the fluid catalytic cracking unit, and automatically adjusting the amount of catalyst dispensed in response to the at least one sensed metric.

### CROSS REFERENCE TO OTHER RELATED APPLICATIONS

This application is a continuation-in-part of co-pending U.S. patent application Ser. No. 10/374,450, filed Feb. 26, 2003, a continuation-in-part of co-pending U.S. patent application Ser. No. 10/304,670, filed Nov. 26, 2002, and a continuation-in-part of co-pending U.S. patent application Ser. No. 10/320,064, filed Dec. 16, 2002, all of which are hereby incorporated by reference in their entireties.

### BACKGROUND OF THE INVENTION

1. Field of the Invention

Embodiments of the invention generally relate to a fluid catalytic cracking catalyst injection system.

2. Description of the Related Art

FIG. 1 is a simplified schematic of a conventional fluid catalytic cracking system 130. The fluid catalytic cracking system 130 generally includes a fluid catalytic cracking (FCC) unit 110 coupled to a catalyst injection system 100, an oil feed stock source 104, an exhaust system 114 and a distillation system 116. One or more catalysts from the catalyst injection system 100 and oil from the oil feed stock source 104 are delivered to the FCC unit 110, The oil and catalysts are combined to produce an oil vapor that is collected and separated into various petrochemical products in the distillation system 116. The exhaust system 114 is coupled to the FCC unit 110 and is adapted to control and/or monitor the exhausted byproducts of the fluid cracking process.

The catalyst injection system 100 includes a main catalyst source 102 and one or more additive sources 106. The main catalyst source 102 and the additive source 106 are coupled to the FCC unit 110 by a process line 122. A fluid source, such as a blower or air compressor 108, is coupled to the process line 122 and provides pressurized fluid, such as air, that is utilized to carry the various powdered catalysts from the sources 102, 106 through the process line 122 and into the FCC unit 110.

A controller 120 is utilized to control the amounts of catalysts and additives utilized in the FCC unit 110. Typically, different additives are provided to the FCC unit 110 to control the ratio of product types recovered in the distillation system 116 (i.e., for example, more LPG than gasoline) and to control the composition of emissions passing through the exhaust system 114, among other process control attributes. As the controller 120 is generally positioned proximate the catalyst sources 106, 102 and the FCC unit 110, the controller 120 is typically housed in an explosion-proof enclosure to prevent spark ignition of gases which may potentially exist on the exterior of the enclosure in a petroleum processing environment.

The catalyst is typically added periodically to the FCC unit based on a predefined production schedule. The schedule (i.e., the timing and quantity) of catalyst injected is typically preprogrammed into the controller by the facility production planners and may be manually augmented during the refining process to control the emissions and product mix.

However, due to the uncertain chemical make-up of the oil feed stock entering the FCC system, both the emissions and the product mix may vary or drift from process targets during the course of refining. This requires production planners and system operators to closely monitor system outputs, and to be constantly available to make manual adjustments to the catalyst injection schedule as needed. Thus, it would be beneficial to remotely monitor and make adjustments through catalyst injections to the system outputs while reducing the reliance on human interactions such as monitoring and manual changes to the catalyst injection schedule.

Therefore, there is a need for an improved FCC injection system.

### SUMMARY OF THE INVENTION

The invention is a system and method for closed loop control of a fluid catalyst cracking (FCC) catalyst injection system. In one embodiment, a system for injecting catalyst into a FCC unit includes at least one catalyst injection apparatus for providing catalyst to a fluid catalyst cracking unit, at least one sensor adapted to provide a metric indicative of an output produced in the fluid catalyst cracking unit, and a controller coupled to the sensor, for controlling the additions made by the catalyst injection system in response to the metric provided by the sensor.

Another embodiment of the invention comprises a method for injecting catalyst from a catalyst injection system into a FCC unit that includes the steps of dispensing catalyst for a catalyst injection system into a fluid catalytic cracking unit, sensing an output in the fluid catalytic cracking unit, and automatically adjusting the amount of catalyst dispensed in response to the at least one sensed metric.

### DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a simplified schematic view of a conventional fluid catalytic cracking system;

FIGS. 2A-B are a simplified schematic diagram of a fluid catalytic cracking system illustrating an injection system depicting a first embodiment of a control module configured to provide local data access in accordance with one embodiment of the present invention;

FIG. 3 is a sectional, isometric view of one embodiment of a control valve used in conjunction with the present invention;

FIG. 4 is a simplified schematic view of another embodiment of a control module configured to provide local data access;

FIG. 5 is a simplified schematic view of another embodiment of a control module configured to provide local data access; and

FIG. 6 is a simplified view of another embodiment of an injection system.

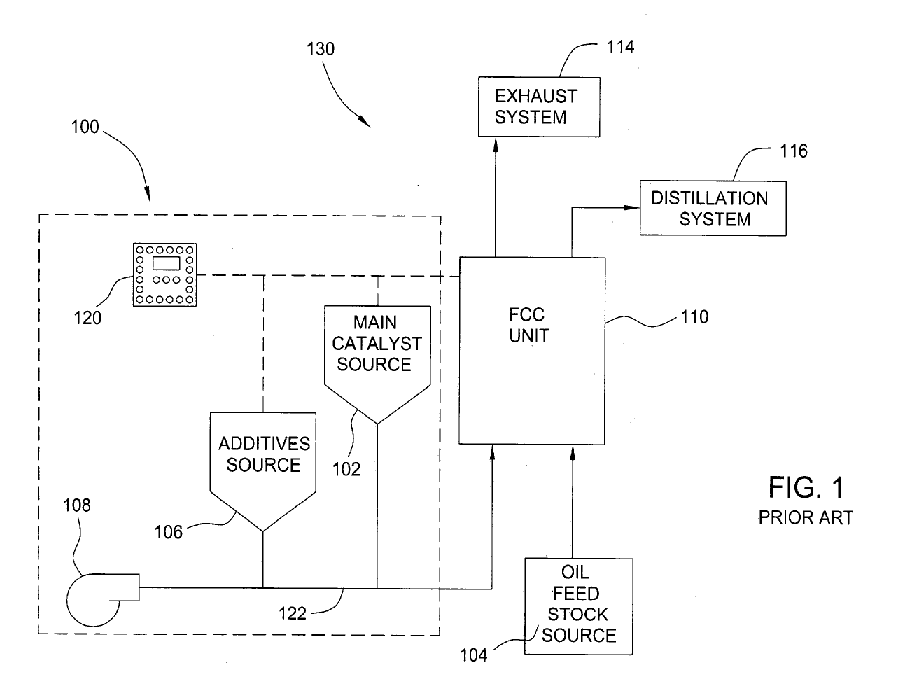

To facilitate understanding, identical reference numerals have been used, wherever possible, to designate identical elements that are common to the figures.

### DETAILED DESCRIPTION

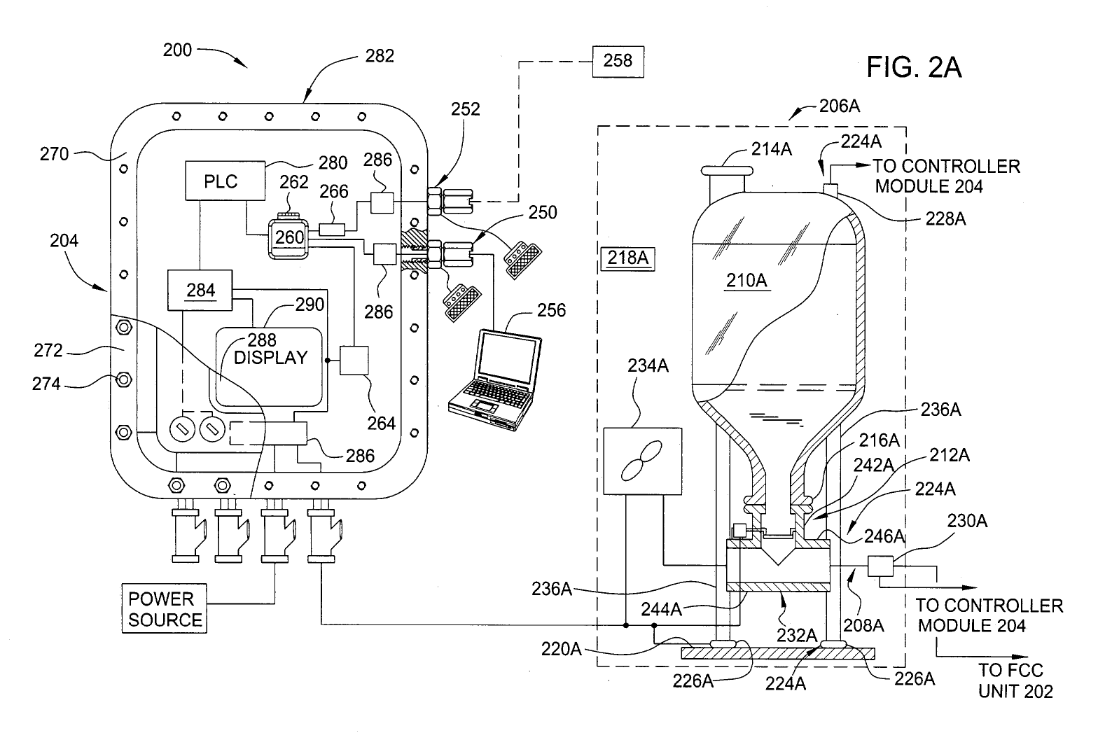

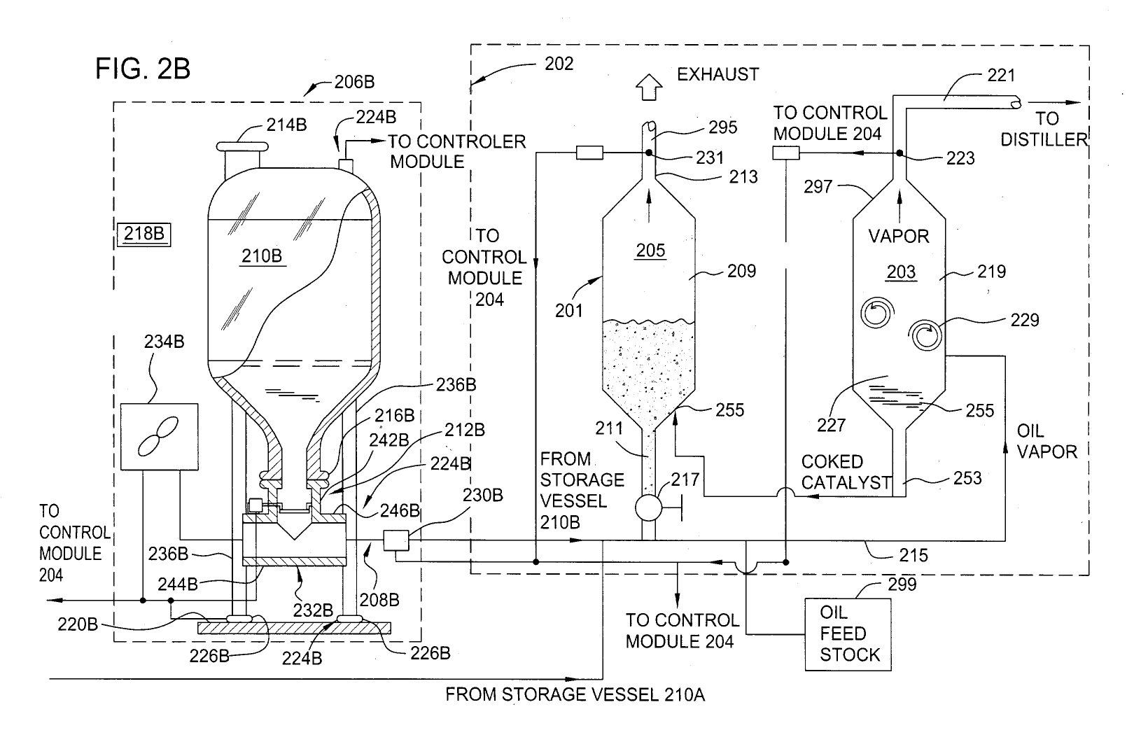

FIGS. 2A-B depict one embodiment of a fluid catalytic cracking (FCC) system 200 configured to facilitate closed loop control of catalyst injections to control at least one of system emissions, product mix and the like. The FCC system 200 includes a fluid catalytic cracking (FCC) unit 202 coupled to a distiller (not shown), and one or more catalyst injection systems. The FCC system 200 is also coupled to a control module 204. This is interfaced with at least one sensor adapted to provide a metric indicative of an attribute of the system 200 such as system emissions, product mix and the like.

The FCC unit 202 includes a regenerator 205 coupled to a cracking chamber 203. The regenerator 205 comprises a vessel 201 having an interior volume 209, a catalyst receiving port 255, a catalyst exit port 211, and a flue exhaust port 213 coupled to a stack 295. Catalyst flows from the exit port 211 of the regenerator 205 through a delivery line 215 to the cracking chamber 203. A valve 217 located at the exit port 211 controls the amount of catalyst flowing from the regenerator 205 into the delivery line 215. The catalyst in the delivery line 215 mixes and reacts with oil feed stock flowing through the line into the cracking chamber 203 from an oil feed stock source 299. Catalyst, partially deactivated by coke during the cracking reaction, is returned to the regenerator 205 from the cracking chamber 203. The returned catalyst is heated in the regenerator 203 to remove the deposited coke, thus conditioning the catalyst for reuse in the cracking chamber 203. Combustion by-products from the coke-removing process exit the regenerator 205 through the flue exhaust port 213 and stack 295.

The cracking chamber 203 is adapted to receive the crude oil and oil vapor produced in the delivery line 215 and separate the catalyst particles from the oil vapor. The cracking chamber 203 includes a vessel 297 having an interior volume 219, a first exit port 221 coupled to the distiller (not shown), and a second exit port 253 coupled to the regenerator 205. The catalyst particles 225, which are partially deactivated by deposited coke during the cracking process, settle in a lower portion 227 of the interior volume 219 and are periodically returned to the regenerator 205 via the second exit port 253. The oil vapor comprising a petroleum product mix exits the vessel 297 through the first exit port 221 to the distiller for separation and condensation into various petroleum products.

One or more catalyst injection systems are coupled to the FCC unit 202 to supply and/or replenish catalyst. In the embodiment depicted in FIGS. 2A-B, a first catalyst injection system 206A and a second catalyst injection system 206B are shown. It is contemplated that any number of catalyst injection systems, or a single system for selectively injecting catalyst from a plurality of catalyst sources, may be utilized.

The first catalyst injection system 206A is coupled by the delivery line 215 to the FCC unit 202. The injection system 206A is coupled to the control module 204 that controls the rates and/or amounts of catalyst that are delivered by the injection system 206A into the delivery line 215.

In one embodiment, the first catalyst injection system 206A includes a storage vessel 210A coupled to a metering device 212A. The metering device 212A is typically coupled to the control module 204 so that an amount of catalyst delivered to the delivery line 215 may be monitored or metered. Exemplary injection systems that may be adapted to benefit from the invention are described in U.S. Pat. No. 5,389,236, issued Feb. 14, 1995, and in U.S. Pat. No. 6,358,401, issued Mar. 19, 2002, both of which are hereby incorporated by reference in their entireties. Other catalyst injection systems that may be adapted to benefit from the invention are available from Intercat, Inc. of Sea Girt, N.J.

The storage vessel 210A is typically a metal container having a fill port 214A and a discharge port 216A. Typically, the discharge port 216A is positioned at or near a bottom of the storage vessel 210A. The storage vessel 210A is coupled to a pressure control apparatus 218A that controls the pressure within the storage vessel 210A. The pressure control apparatus 218A generally pressurizes the storage vessel 210A to about 5 to about 60 pounds per square inch (about 0.35 to about 4.2 kg/cm²) during dispensing operations. The apparatus 218A intermittently vents the storage vessel 210A to about atmospheric pressure to accommodate recharging the vessel 210A with catalyst.

A metering device 212A is coupled to the discharge port 216A to control the amount of catalyst injected from the storage vessel 210A to the regenerator. The metering device 212A may be a shut-off valve, a rotary valve, a mass flow controller, a shot pot, a flow sensor, a positive displacement pump or other devices suitable for regulating the amount of catalyst dispensed from the storage vessel 210A for delivery to the delivery line 215. The metering device 212A may determine the amount of catalyst by weight, volume, timed dispense or by other manners. Depending on the catalyst requirements of the system 100, the metering device 212A is typically configured to provide about 5 to about 4000 pounds per day of additive-type catalysts (process control catalyst) or may be configured to provide about 1 to about 20 tons per day of main catalyst. The metering device 212A typically delivers catalysts over the course of a planned production cycle, typically 24 hours, in multiple shots of predetermined amounts spaced over the production cycle. However, catalysts may also be added in an “as needed” basis or in response to information provided by a closed loop system output monitoring device or sensor.

In the embodiment depicted in FIGS. 2A-B, the metering device 212A is a control valve 232A that regulates the amount of catalyst delivered from the storage vessel 210A to the delivery line 215 by a timed actuation. The control valve 232A generally includes a first port 242A that is coupled to the discharge port 216A of the storage vessel 210A. A second port 244A of the control valve 232A is coupled to a portion of the delivery line 208A that merges with a fluid source 234A such as a blower or compressor. A third port 246A of the control valve 232A is coupled to a portion of the delivery line 208A leading to the delivery line 215. When actuated to an open position, the control valve 232A allows catalyst to flow from the storage vessel 210A towards the third port 246A, where fluid provided from the fluid source 234A, moving from the second port 244A towards the third port 246A entrains and carries the catalyst to the delivery line 215. In one embodiment, the fluid source 234A provides air at about 60 psi (about 4.2 kg/cm²).

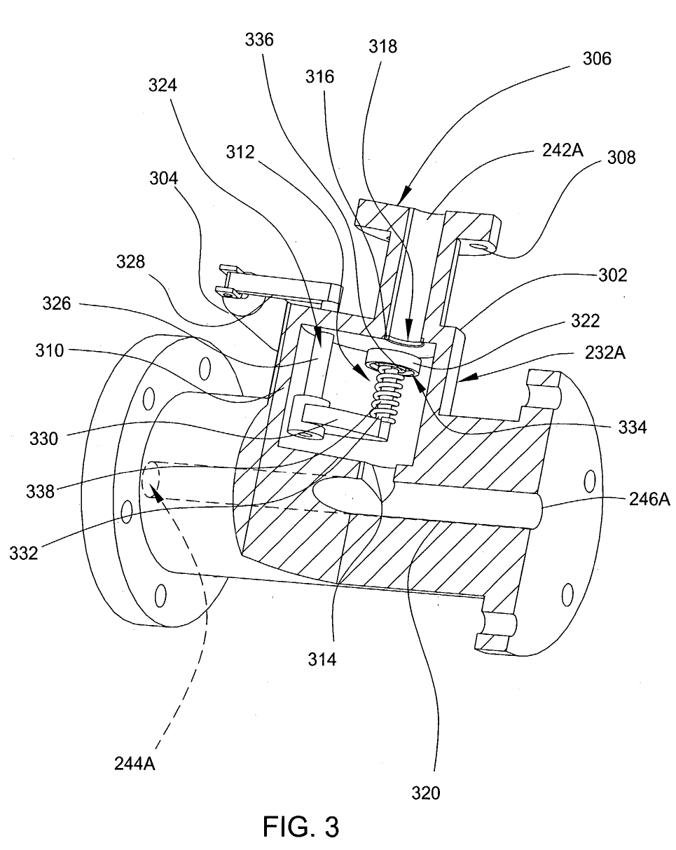

FIG. 3 is a sectional, isometric view of one embodiment of the control valve 232A. The control valve 232A includes a valve body 302 and an actuator 304. The valve body 302 includes a first flange 306 having the first port 242A formed therethrough. The first flange 306 also includes a plurality of mounting holes 308 to facilitate coupling the valve body 302 to the discharge port 216A of the storage vessel 210A shown in FIGS. 2A-B. The first flange 306 is coupled to a housing 310. The housing 310 of the valve body 302 defines a cavity 312 that is coupled to the first port 242A by a valve seat 316 disposed at one end and a first passage 314 coupled to a second passage 320 (shown in partially in phantom) that couples the second and third ports 244A, 246A at a second end. The valve seat 316 has an orifice 318 formed therethrough that fluidly couples the cavity 312 to the discharge port 216A of the storage vessel 210A (shown in FIGS. 2A-B). The orifice 318 is typically between about ⅞ to about 1¾ inches in diameter.

The orifice 318 of the control valve 232A is opened and closed by selectively moving a shear disk 322 laterally across the seat 316. The shear disk 322 generally has a lapped metallic upper sealing surface that seals against the valve seat 316, which is typically also metallic. As the shear disk 322 is disposed on the downstream side of the valve seat 316, any backpressure generated in the regenerator 205 will not inadvertently open the valve 232A.

An actuator assembly 324 couples the shear disk 322 to the actuator 304 that controls the open and closed state of the control valve 232A. The actuator assembly 324 includes a shaft 326 that extends through the housing 310. A first arm 328 of the actuator assembly 324 is coupled to an end of the shaft 326 disposed on the outside of the housing 310. A second arm 330 of the actuator assembly 324 is coupled to an end of the shaft 326 disposed in the cavity 312 of the housing 310. A pin 332 extends from the second arm 330 and engages the shear disk 322. A recess 334 formed in a lower surface of the shear disk 322 receives the pin 332 and prevents the pin 332 and shear disk 322 from becoming disengaged as the pin 332 urges the shear disk 322 laterally over or clear of the orifice 318.

An annular bushing 336 residing in the recess 334 circumscribes the end of the pin 332. The bushing 336 is retained by the pin 332 and can move axially along the pin 332. A diameter of the bushing 336 is generally less than a diameter of the recess 334 to that the shear disk 322 may rotate eccentrically round the bushing 336 and the pin 332 as the shear disk 322 is moved laterally.

A biasing member 338 (e.g., a spring) is disposed around the pin 332 between the second arm 330 and the bushing 336. The member 338 biases the bushing 336 and the shear disk 322 away from the second arm 330 and against the valve seat 316 so that the shear disk 322 seals the orifice 318 when the shear disk 322 is positioned over the valve seat 316.

As depicted in FIG. 3, the actuator 304 is coupled to the first arm 328 and rotates the shaft 326 to move the shear disk 322 between positions that open and close the orifice 318. As the pin and bushing 332, 336 have a diameter smaller than the recess 324 formed in the shear disk 322, the shear disk 322 precesses about the shaft 326 as the control valve 232A is opened and closed (i.e., the shear disk 322 rotates eccentrically about the pin 332 while additionally rotating about the shaft 326). This motion of the shear disk 322 over the valve seat 316 provides a self-lapping, seat cleaning action that prevents the catalyst from grooving the sealing surfaces of the shear disk 322 and valve seat 316 that could cause valve leakage. It has been found that this configuration of valve operation substantially extends the service life of the valve 232A. None the less, the catalyst injection system of the present invention may alternatively utilize other control valves.

Referring back to FIGS. 2A-B, the injection system 206A may also include one or more sensors 224A for providing a metric suitable for resolving the amount of catalyst passing through the metering device 212A during each injection of catalyst. The sensors 224A may be configured to detect the level (i.e., volume) of catalyst in the storage vessel 210A, the weight of catalyst in the storage vessel 210A, the rate of catalyst movement through the storage vessel 210A, discharge port 216A, metering device 212A and/or catalyst delivery line 208A or the like.

In the embodiment depicted in FIGS. 2A-B, the sensor 224A is a plurality of load cells 226A adapted to provide a metric indicative of the weight of catalyst in the storage vessel 210A. The load cells 226A are respectively coupled to a plurality of legs 236A that supports the storage vessel 210A above a surface 220A, such as a concrete pad. Each of the legs 236A has one load cell 226A coupled thereto. The control module 204 receives the outputs of the load cells 226A. From sequential data samples obtained from the load cells 226A, the control module 204 may resolve the net amount of injected catalyst after each actuation of the metering device 212A. Additionally, the net amount of catalyst dispensed over the course of the production cycle may be monitored so that variations in the amount of catalyst dispensed in each individual shot may be compensated for by adjusting the delivery attributes of the metering device 212A, for example, changing the open time of the control valve 232A to allow more (or less) catalyst to pass therethrough and into the regenerator.

Alternatively, the sensor 224A may be a level sensor 228A coupled to the storage vessel 210A and adapted to detect a metric indicative of the level of catalyst within the storage vessel 210A. The level sensor 228A may be an optical transducer, a capacitance device, a sonic transducer or other device suitable for providing information from which the level or volume of catalyst disposed in the storage vessel 210A may be resolved. By utilizing the sensed differences in the levels of catalyst disposed within the storage vessel 210A between dispenses, the amount of catalyst injected may be resolved for a known storage vessel geometry.

Alternatively, the sensor 224A may be a flow sensor 230A adapted to detect the flow of catalyst through one of the components of the catalyst injection system 206A. The flow sensor 230A maybe a contact or non-contact device and may be mounted to the storage vessel 210A, the metering device 212A or the catalyst delivery line 208A coupling the storage vessel 210A to the regenerator. In the embodiment depicted in FIGS. 2A-B, the flow sensor 230A may be a sonic flow meter or capacitance device adapted to detect the rate of entrained particles (i.e., catalyst) moving through the delivery line 208A.

In one embodiment, the first catalyst injection system 206A is adapted to inject an additive into the delivery line 215 to control product mix (i.e., the amount of selected petroleum products produced during the refining process). For example, a catalyst, such as a ZSM-5 or ZMX type additive may be added to control LPG yield or selectivity. That is, the injected catalyst may promote (or retard) the amount of hydrocarbon chain cracking of the petroleum feed stock during refining, thereby optimizing end products recovered in the distiller (for example, higher yields of lighter hydrocarbon chains). Examples of additives that may be advantageously used in the injection system 206A include the ZCAT, PENTCAT and ZMX families of products commercially available from Intercat, Inc. of Sea Girt, N.J., the OLEFIN-MAX and OLEFIN-ULTRA products commercially available from W.R. Grace & Co. of Columbia, Md., or the Z-2000 products commercially available from Engelhard Corporation of Iselin, N.J., among others.

The second catalyst injection system 206B is also coupled to the delivery line 215 and in one embodiment is configured substantially identical to the first catalyst injection system 206A. The injection system 206B is also coupled to the control module 204, which controls the rates and/or amounts of catalyst provided to the delivery line 215 by the injection system 206B. In one embodiment, the second injection system 206B is adapted to introduce additives into the FCC unit 202 to regulate flue gas emissions (i.e., emissions from the coke burning process in the regenerator 205), such as sulfur and/or nitrous oxide control additives to control the sulfur and/or nitrous oxide levels in the exhaust products. Optionally, carbon monoxide levels in the exhaust products may be regulated in a similar fashion. It is contemplated that other process attributes may also be controlled by the introduction of catalysts to the FCC unit 202.

Sulfur oxide control additives that may be used to advantage in the manner described include SOXGETTER, commercially available from Intercat, Inc., members of the DESOX catalyst family, commercially available from W.R. Grace Co., or SOXCAT, commercially available from Engelhard Corporation, among others; nitrous oxide control additives include NOXGETTER, commercially available from Intercat, Inc., DENOX, commercially available from W.R. Grace Co., or CLEANOX, commercially available from Engelhard Corporation, among others; carbon monoxide promoters include the COP family of products commercially available from Intercat, Inc., or the CP range of products commercially available from W.R. Grace Co, among others. Furthermore, several of these commercially available products may be used alone to effectively reduce more than one parameter (for example, in some cases, SOXGETTER may effectively reduce both sulfur and nitrous oxides).

In order to more effectively control the output of the FCC system 200, at least one sensor for detecting a metric indicative of the system's output (i.e., emissions, product mix and the like) is provided. In one embodiment, a first sensor 231 is coupled to the control module 204 and adapted to provide a metric indicative an output produced in the system 200. In one embodiment, the first sensor 231 is adapted to provide a metric indicative of the composition of flue exhaust emissions produced in the regenerator 205. For example, the first sensor 231 may be a flue gas analyzer adapted to monitor emissions that exit the regenerator 205. Examples of emissions that may be monitored by the first sensor 231 include sulfur, carbon monoxide and nitrous oxide, among others. In the embodiment illustrated in FIGS. 2A-B, the sensor 231 is coupled to the flue gas stack 295 leading from the exhaust port 213 of the regenerator 205. In further embodiments, the sensor 231 may be dispersed within the regenerator 205, or the sensor 231 may be positioned in the environment outside FCC system 200, among other locations.

In another embodiment, a second sensor 223 may be utilized to provide a metric indicative of the product mix to the control module 204. In the embodiment depicted in FIGS. 2A-B, the second sensor 223 is adapted to monitor the LPG yield of the vapor that passes from the cracking chamber 223 to the distiller. The sensor 223 may be coupled to the exit port 221 of the cracking chamber 203, although in further embodiments, it is contemplated that the sensor 223 may be positioned elsewhere to monitor the LPG stream or other metrics relating to the product mix, for example, the amount of diesel fuel or gasoline, among others.

In another embodiment, the sensor 223 may be a plurality of sensors disposed on different parts of the distillation and separation processes downstream of the FCC units 202. The sensors are coupled to the control module 204 and utilized to resolve a calculated output value, For example, if there are just two streams leaving the FCC unit 202 that contain propylene, flow and composition sensors disposed on both of these streams may be adapted to provide data utilized by the control module 204 to calculate the total amount of propylene leaving the FCC unit. It is contemplated that other outputs may be monitored similarly, and so on.

The sensors 231, 223 provide a signal to the control module 204 that is utilized to control the release of additives by the catalyst injection systems 206A, 206B. The sensors 231, 223 provide real-time feedback of conditions within the FCC system 200, thereby allowing the catalyst injection systems 206A, 206B to adjust the catalyst addition schedule to optimize the system 200 on a real time basis. Accordingly, system outputs (such as emissions or product mix) may be optimized with little to no human intervention.

In one embodiment, the control module 204 generally includes a controller 280 housed in an enclosure 282 that is suitable for service in hazardous locations. In one embodiment, the enclosure 282 is fabricated in accordance with NEC 500 Division 1, Class 1, or other similar standard.

The enclosure 282 includes a housing 270 having a cover 272 fastened thereto by a plurality of bolts 274. The housing 270 and cover 272 are typically fabricated from cast aluminum and have machined mating services that form a sealed cavity.

The controller 280 may be any suitable logic device for controlling the operation of the catalyst injection system 206. In one embodiment, the controller 280 is a programmable logic controller (PLC), such as those available from GE Fanuc. However, from the disclosure herein, those skilled in the art will realize that other controllers such as microcontrollers, microprocessors, programmable gate arrays, and application specific integrated circuits (ASICs) may be used to perform the controlling functions of the controller 280.

The controller 280 is coupled to various support circuits 284 that provide various signals to the controller 280. These support circuits include, power supplies, clocks, input and output interface circuits and the like. One of the support circuits 284 is coupled to a display 290 that displays process information and/or system status. The display 290 can be viewed through a window 288 disposed in the cover 272 of the enclosure 282. Another one of the support circuits 284 couples the sensors 224 to the controller 280.

All signals to and from the controller 280 and the support circuits 284 that pass to the exterior of the enclosure 282 must pass through an intrinsically safe barrier 286 to prevent power surges that may potentially ignite fumes present in the environment surrounding the enclosure 282. In one embodiment, the intrinsically safe barrier 286 is a Zener diode that substantially prevents voltage spikes from leaving the enclosure 282. The Zener diode is coupled from a conductive path carrying the signal to or from the interior of the enclosure 282 to ground. As such, any voltage spikes that exceed the breakdown voltage of the Zener diode will be shorted to ground and, thus, not leave the enclosure 282.

The controller 280 typically includes or is coupled to a processor 260 that manages data provided by the sensors 224. In one embodiment, the processor 260 is coupled to controller 280 and powered by a power source 264 disposed within the enclosure 282. The processor 260 writes information from the system 100 to a memory device 262. The information recorded in the memory device 262 may include data from the sensors 224 indicative of the amount of catalyst injected into the FCC unit 110, error messages from the controller 280, a record of operator activity, such as refilling the addition system, times of manually interrupting and restarting additions, any additions that are made manually which are in addition to any controlled additions, and an hourly weight record of how much catalyst is left in the storage vessel 210, among other information available to the controller 280 regarding system activity. The memory device 262 may be in the form of a hard disk, a floppy drive, a compact disc, flash memory or other form of digital storage. In one embodiment, the processor 260 is a C-Engine processor manufactured by ADPI, located in Troy, Ohio.

At least a first communication port 250 is coupled through the intrinsically safe barrier 286 to the processor 260 and/or controller 280 to facilitate communication with a device outside the enclosure 280. For example, the first communication port 250 accessible from the exterior of the enclosure 280 may provide access to data stored in the memory device 262. The first communication port 250 may alternatively be utilized to communicate with the controller 280, for example, to revise the ladder logic stored in the PLC. In the embodiment depicted in FIGS. 2A-B, the first communication port 250 is coupled to a local device 256, such as a lap top computer or PDA, to access data stored in the memory device 262. The ability to extract and/or access catalyst consumption information and/or other data stored in the memory device 262 of the processor 260 from a local device 256 without having to unbolt the cover 272 from the enclosure 280 to access the memory device 262 eliminates the need for access authorization and the associated downtime involved with opening the enclosure 282.

The first communication port 250 may be a serial port or a parallel port having one or more conductors that penetrate the wall of the enclosure. For convenience, a standard RS-232-type jack that is configured for uses in this environment may be utilized. The first communication port 250 penetrates housing 270 or cover 272 of the enclosure 280 to enable data communications to occur with the controller while the enclosure 280 remains sealed. The processor 260 is programmed in a conventional manner to utilize the first communication port 250.

In the embodiment depicted in FIGS. 2A-B, a second communication port 252 may pass through the housing 270 or cover 272 of the enclosure 282. The second communication port 252 is coupled through the intrinsically safe barrier 286 to a modem 266. The modem 266 enables the processor 260 to communicate to a communications network such as a wide area network, thereby allowing the memory device 262 of the processor 260 to be accessed from a remote device 258 over fixed communication lines, such as a telephone line, ISDN, DSL, T1, fiber optic and the like. As such, the remote device 258 may be a computer terminal that interacts with the system 200 via the Internet. In another embodiment, the remote device 258 may be a refinery process control computer. Alternatively, the modem 266 may facilitate wireless telephonic/data communication, i.e., the modem may be a wireless modem.

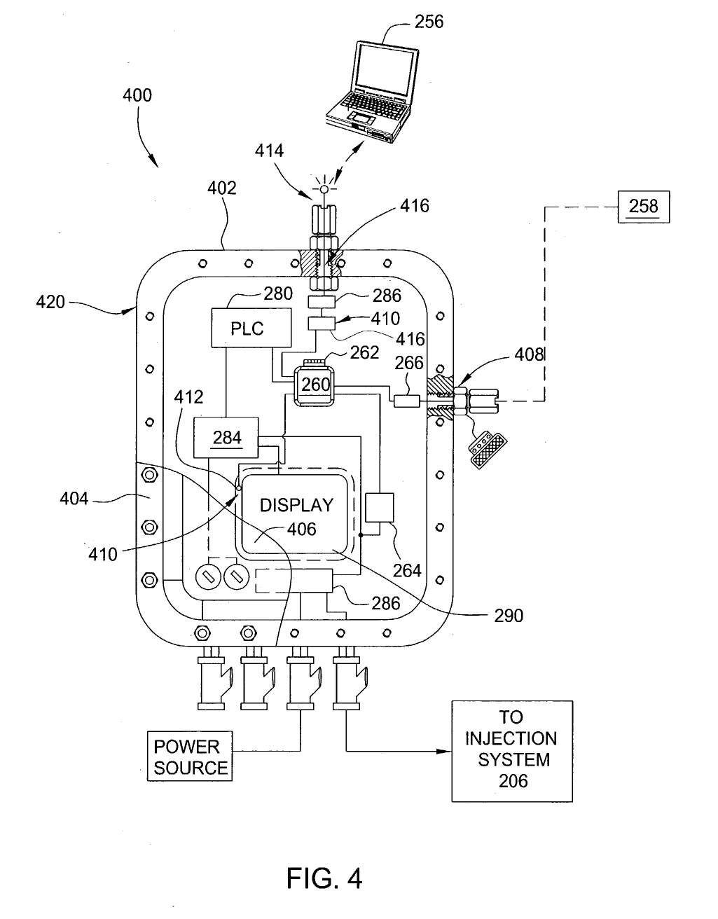

FIG. 4 is a simplified schematic of another embodiment of a control module 400 configured to facilitate closed loop control over one or more of the outputs of system 200. The control module 400 generally includes a housing 402 and a cover 404 that define a hazardous duty enclosure 420 that houses a controller 280. The controller 280 is generally coupled to the injection system 206 through an intrinsically safe barrier 286 disposed in the enclosure 420.

The controller 280 is coupled to a processor 260 that manages a memory device 262 of the injection system. Local access to the memory device 262 is provided through a wireless transceiver 410 and a coupler 414 such as an antenna. The transceiver 410 is located within the enclosure 420 and is coupled through the intrinsically safe barrier 286 to an electrical connector 416 that penetrates the enclosure 420. The coupler 414 is coupled to the connector 416 on the outside of the enclosure 420 such that signals can be coupled between a remote device 256 and the processor 260 via the coupler 414. The remote device 256 may be a lap top computer or PDA that is brought within communication range the coupler 414. The communication between the remote device 256 and the transceiver 410 may be accomplished using, for example, a standard IEEE 802.11 protocol or some other wireless data communications protocol.

Alternatively, the coupler 414 may be disposed within the enclosure 420 such that signals can be coupled to and from a remote device 256 through a material transmissive to the signal comprising at least a portion of the enclosure 420. For example, the signal may pass through a window 406 formed in the enclosure 420, shown disposed in the cover 404 in FIG. 4. Alternatively, at least one of the housing 402 or cover 404 of the enclosure 420 may be at least partially fabricated from the material transmissive to the signal between the remote device 256 and the transceiver 410.

In another embodiment, the transceiver 410 may be an optical transceiver 412 positioned within the enclosure 420 and the coupler 414 may be an opto-coupler. As such, information may be “beamed” through the window 406, disposed in the cover 404. Optionally, the control module 400 may additionally include a second communication port 408 accessible from the exterior of the enclosure 420 that is coupled to the processor 206 via a modem 266.

Closed loop control of the outputs for the FCC system 200 may be executed by the control 204 using data from at least one of the sensors 223, 231 or alternatively may be executed by a remote controller coupled to the control module 400, for example, coupled to the controller 400 through a modem 260. Closed loop control may be utilized to optimize the outputs of the FCC system 200 by providing an automated means of adjusting a pre-set catalyst injection schedule (for example, a schedule that periodically injects a predetermined amount of catalyst into the system 200) to account for real-time output variation or drift detected using feedback provided by at least one of the sensors 223, 231.

The operation of the closed loop system is initiated when the at least one sensor 223, 231 senses a system output (e.g., emissions from the regenerator 205, product mix, or the like) of the FCC system 200 and sends a signal to the control module 400 indicative of the output. The control module 400 determines, based on the information provided by the sensor(s) 223, 231, the amount of catalyst required by the system 200 to function at optimal efficiency (e.g., the amount of catalyst required to return the system's outputs to within a predefined process window. For example, catalyst additions in response to a sensed output metric may be utilized to maintain the system 200 at an acceptable level or to derive a desired product mix from the feed stock oil).

For example, the control module 400 may determine from a metric provided by at least one of the sensors 223, 231 at any point during the operation of the system 200 that additional catalyst is required by the system 200 to supplement the regular catalyst injection schedule. Thus, the control module 400 may resolve an amount of catalyst to be added to the next scheduled injection or to be dispensed immediately. Alternatively, the control module 400 may determine utilizing sensor data that less catalyst is necessary than is dictated by the catalyst injection schedule, and may reduce the amount of catalyst dispensed by the next scheduled injection. The control module 400 may further determine that no changes need to be made to the pre-set catalyst injection schedule, and will neither add nor subtract catalyst to the regularly-schedules injection(s). The control module 400 may therefore dispense or withhold catalyst in response to the data received from the sensor(s) 223, 231, and the amounts of catalyst dispensed with each injection are subsequently recorded and stored by the control module 400 so that the amounts catalyst remaining in the storage vessel(s) are known.

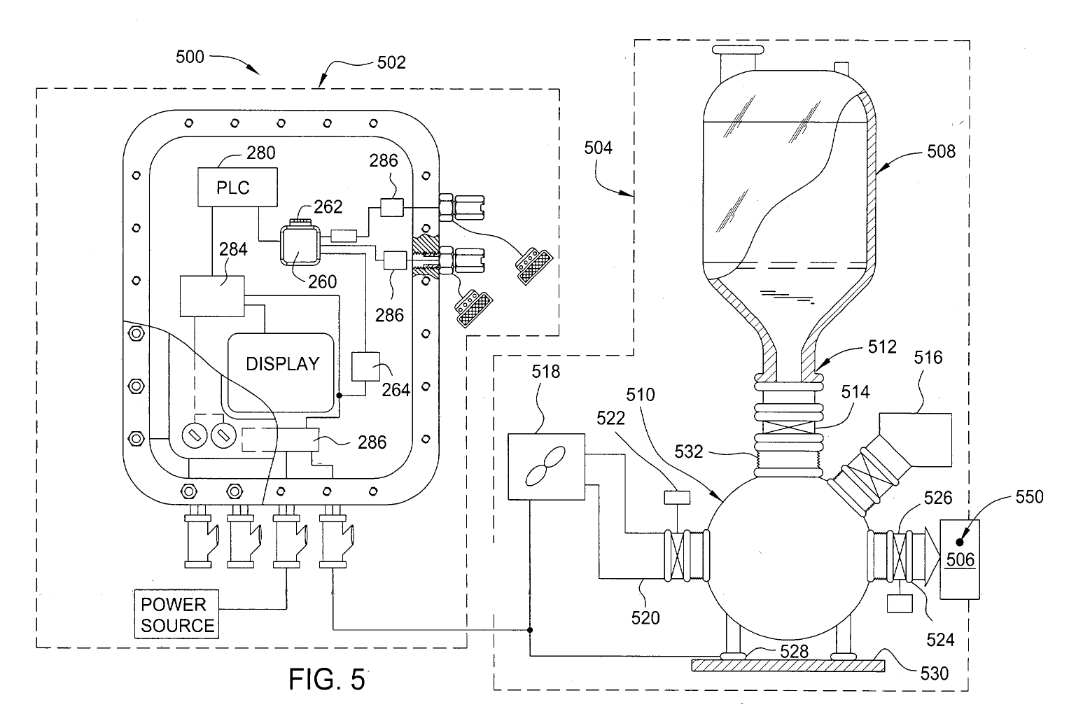

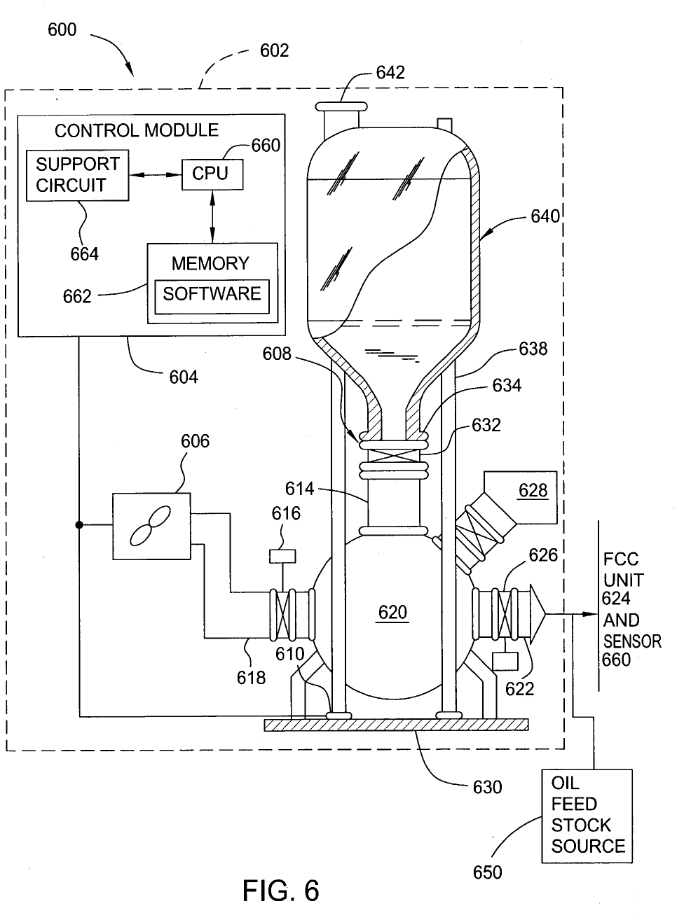

FIG. 5 is a simplified view of another embodiment of an injection system 500 that may be used in place of injection systems 206A, 206B. The system 500 includes a control module 502 for controlling a catalyst injection system 504 coupled to an FCC unit 506. The controller 502 is substantially similar to the control modules described above.

The injection system 504 includes a bulk storage vessel 508 and a shot pot 510. The storage vessel 508 is generally adapted to store catalyst therein at substantially atmospheric pressures. A discharge port 512 of the storage vessel 504 is coupled by a shut-off valve 514 to the shot pot 510. The shut-off valve is periodically selectively opened to fill the shot pot 510 with catalyst. Once the shot pot 510 is filled with a pre-defined amount of catalyst, the shut-off valve 514 is closed, and the shot pot 510 is pressurized by a pressure control system 516 that elevates the pressure of the catalyst and gases within the shot pot 510 to a level that facilitates injection of the catalyst into the FCC unit 506, typically at least about 10 pounds per square inch.

A fluid handler 518 is coupled to the shot pot 510 by a first conduit 520. The first conduit 520 includes a shut-off valve 522 that selectively isolates the fluid handler 518 from the shot pot 510. A second conduit 524 couples the shot pot 510 to the FCC unit 506 and includes a second shut-off valve 526 that selectively isolates the shot pot 510 from the FCC unit 506. Once the shot pot 510 is filled with catalyst and the shut-off valve 514 is closed, the shot pot 510 is brought up to pressure and the shut-off valves 522, 526 are opened to facilitate movement of the catalyst from the shot pot 510 to the FCC unit 506 by air delivered through the shot pot 510 by the fluid handler 518.

The weight of the shot pot 510 is monitored to control the amount of catalyst dispensed into the shot pot 510 from the storage vessel 508. A plurality of load cells 528 are typically coupled between the shot pot 510 and a mounting surface 530 to provide the control module 502 with a metric indicative of the weight of the catalyst and shot pot 510 which may be utilized to resolve the amount of catalyst in the shot pot 510. In order to provide the necessary isolation of the shot pot 510 from its surrounding components needed to obtain accurate data from the load cells 528, a plurality of bellows 532 are coupled between the shut-off valves 514, 522, 526 and the pressure control system 516. The bellow 532 allow the shot pot 510 to move independently from the conduits and other components coupled thereto so that substantially all of the weight of the shot pot 510 and catalyst disposed therein is borne on the load cells 528.

The control module 502 is coupled to at least one sensor 550 adapted to provide a metric indicative of an output of the FCC unit 506. The at least one sensor 550 may be adapted to function similar to the sensors 223, 231 described above with reference to FIGS. 2A-B—for example, the sensor 550 may be adapted to provide information concerning FCC unit emissions, product mix and the like to the control module 502. The control module 502 is adapted to control the dispense of catalyst into the FCC unit 506 in response to the data provided by the at least one sensor 550.

In another embodiment of an FCC system 600, the FCC system 600 comprises at least one injection system 602 and oil feed stock source 650 coupled to an FCC unit 624. The injection system 602 includes a control module 604 coupled to at least one sensor 660 adapted to provide a metric indicative of the output of the FCC unit 624. The control module 604 is adapted to control the rates and/or amounts of catalyst provided to the FCC unit 624 by the injection system 602.

The at least one injection system 602 includes at a storage vessel 640 coupled to a metering device 608. The metering device 608 is coupled to the control module 604 so that an amount of catalyst delivered to the FCC unit 624 may be monitored and/or metered. The metering device 608 couples the storage vessel 640 to a catalyst delivery line 614 that delivers catalyst to a pressure vessel 620 positioned below the storage vessel 640.

The pressure vessel 620 has an operational pressure of about zero to one hundred pounds per square inch and is coupled to a fluid source 606 by a first conduit 618. The first conduit 618 includes a shut-off valve 616 that selectively isolates the fluid source 606 from the pressure vessel 620. A second conduit 622 couples the pressure vessel 620 to the FCC unit 624 and includes a second shut-off valve 626 that selectively isolates the pressure vessel 620 substantially from the FCC unit 624. The shut-off valves 616 and 626 are generally closed to allow the pressure vessel 620 to be filled with catalyst from the storage vessel 640 at substantially atmospheric pressure.

Once catalyst is dispensed into the pressure vessel 620, a control valve 632 on the storage vessel 640 is closed and the interior of the pressure vessel 620 is pressurized by a pressure control system 628 to a level that facilitates injection of the catalyst from the pressure vessel 620 into the FCC unit 624, typically at least about twenty pounds per square inch. After the loaded pressure vessel 620 is pressurized by the pressure control system 628, the shut-off valves 616 and 626 are opened, allowing air or other fluid provided by the fluid source 606 to enter the pressure vessel 620 through the first conduit 618 and carry the catalyst out of the pressure vessel 620 through the second conduit 622 to the FCC unit 624. In one embodiment, the fluid source 606 provides air at about sixty to about one hundred pounds per square inch (about 4.2 to about 7.0 kg/cm2).

The at least one sensor 660 may be coupled to the FCC unit 624 is adapted to provide a metric indicative of the output of the FCC unit 624. The at least one sensor 660 may be adapted to function similar to the sensors 223, 231 described above with reference to FIGS. 2A-B—for example, the sensor 660 may be adapted to provide information concerning FCC unit emissions, product mix and the like to the control module 604. The control module 604 is adapted to dispense catalyst to the FCC unit 624 in response to the data provided by the at least one sensor 660, according to the method previously described herein.

Thus, an injection system has been provided that facilitates closed loop control over the outputs of an FCC unit. In one embodiment, the inventive system allows emissions to be controlled in real time. In another embodiment, the product mix may be controlled in real time to ensure optimum processing efficiency and realization of production goals with minimal or no human intervention.

Although the teachings of the present invention have been shown and described in detail herein, those skilled in the art can readily devise other varied embodiments that still incorporate the teachings and do not depart from the scope and spirit of the invention.

What is claimed is:

1. A system for injecting catalyst into a fluid catalyst cracking unit, comprising:
at least one catalyst injection apparatus for delivering catalyst to a fluid catalyst cracking unit;
at least one sensor adapted to provide a metric indicative of an output of the fluid catalyst cracking unit; and
a controller coupled to the sensor, for controlling catalyst additions made by the catalyst injection system in response to the metric provided by the sensor.

2. The system of claim 1, further comprising:
an enclosure suitable for hazardous service, for housing the controller; and
a communication port coupled to the controller for communicating information regarding activity of the catalyst injection apparatus to a device remote from the enclosure while the enclosure is sealed.

3. The system of claim 1, wherein the at least one sensor is adapted to provide a metric indicative of the composition of flue exhaust emissions produced in the fluid catalyst cracking unit.

4. The system of claim 3, wherein the catalyst injection system further comprises:
a storage vessel; and
at least one additive disposed in the storage vessel for controlling at least one of sulfur oxide, nitrous oxide, or carbon monoxide content in the flue exhaust emissions.

5. The system of claim 3, wherein the sensor is coupled to an exhaust port of a catalyst regenerator of the fluid catalyst cracking unit.

6. The system of claim 1, wherein the at least one sensor is adapted to provide a metric indicative of a product mix exiting the fluid catalyst cracking unit.

7. The system of claim 6, wherein the catalyst injection system further comprises:
a storage vessel; and
at least one additive disposed in the storage vessel for promoting the cracking of hydrocarbon chains in the product mix.

8. The system of claim 6, wherein the catalyst injection system further comprises:
at least one additive disposed in the storage vessel for controlling the amount of liquid petroleum gas produced in the fluid catalyst cracking unit.

9. The system of claim 6, wherein the sensor is disposed between an exit port of the fluid catalyst cracking unit and a distiller.

10. The apparatus of claim 1, wherein a catalyst injection system further comprises:
a storage vessel;
a metering device coupled to the storage vessel and having an output adapted for coupling to the fluid catalyst cracking unit; and
a catalyst sensor adapted to detect a metric indicative of a change in the amount of catalyst disposed in the storage vessel.

11. The system of claim 1, wherein the catalyst injection system further comprises:
a storage vessel; and
a valve body having a first port coupled to an aperture of the storage vessel;
a second port adapted for coupling to the fluid cracking unit; and
a third port adapted for coupling to a fluid supply.

12. The system of claim 11, wherein the valve body further comprises:
a passage formed between the second and third port;
a cavity having the first port disposed at one end and a valve seat disposed at a second end;
an orifice disposed through the valve seat and coupling the cavity to the passage; and
a shear disk disposed in the cavity and selectively sealing the orifice, the shear disk adapted have a precession motion while moving over the valve seat.

13. The system of claim 2, wherein the communications port comprises at least one of a serial port, a parallel port, a wireless transceiver, or an optical transceiver.

14. The system of claim 2, wherein the controller further comprises a modem coupled to the controller.

15. The system of claim 2, wherein the communication port is accessible from an exterior of the enclosure while the enclosure is sealed.

16. A system for injecting catalyst into a fluid catalyst cracking unit, comprising:
a storage vessel;
a metering device coupled to the storage vessel and having an output adapted for coupling to the fluid catalyst cracking unit;
at least one catalyst sensor for providing a metric indicative of the amount of catalyst dispensed into the metering device;
at least one process sensor adapted to provide a metric indicative of an output of the fluid catalyst cracking unit; and
a controller for controlling to metering device in response to metric provided by the process sensor.

17. The system of claim 16, wherein the controller further comprises:
a memory device for storing information derived from the metrics provided by the sensors.

18. The system of claim 17, further comprising:
an enclosure suitable for hazardous service, for housing the controller; and
a communication port coupled to the controller for communicating information stored in the memory device to a remote device while the enclosure is sealed.

19. The apparatus of claim 16, wherein the at least one sensor is adapted to provide a metric indicative of the composition of the flue exhaust emissions produced in the fluid catalyst cracking unit.

20. The system of claim 16, wherein the at least one sensor is adapted to provide a metric indicative of a product mix exiting the fluid catalyst cracking unit.

21. The system of claim 16, wherein the metering device further comprises:
a valve body having a first passage teed with a second passage;
a valve seat having the first passage extending therethrough; and
a shear disk disposed in the valve body and selectively moving over the valve seat in a precession motion.

22. A method for injecting catalyst into a fluid catalytic cracking unit, comprising:
dispensing catalyst for a catalyst injection system into a fluid catalytic cracking unit;
sensing at least one output of the fluid catalytic cracking unit; and
automatically adjusting an amount of catalyst dispensed in response to the at least one sensed output.

23. The method of claim 22, wherein the step of sensing the at least one output further comprises:
sensing the composition of flue exhaust emissions produced by the fluid catalytic cracking unit.

24. The method of claim 23, wherein the step of adjusting the amount of catalyst further comprises:
dispensing at least one additive for controlling the amount of at least one of sulfur oxide, nitrous oxide, or carbon monoxide in the flue exhaust emissions.

25. The method of claim 22, wherein the step of sensing the at least one output further comprises:
sensing a composition of a petroleum product mix exiting the fluid catalytic cracking unit.

26. The method of claim 25, wherein the step of adjusting the amount of catalyst further comprises:
dispensing at least one additive for promoting the cracking of hydrocarbon chains in the product mix.

27. The method of claim 25, wherein the step of adjusting the amount of catalyst further comprises:
dispensing at least one additive for controlling a ratio between petroleum products produced.
